(19) United States
(12) Patent Application Publication
(10) Pub. No.: US 2016/0257786 A1
(43) Pub. Date: Sep. 8, 2016

(54) DEGRADABLE DOWNHOLE TOOLS COMPRISING THIOL-BASED POLYMERS

(71) Applicant: HALLIBURTON ENERGY SERVICES, INC., Houston, TX (US)

(72) Inventors: Michael Linley Fripp, Carrollton, TX (US); Xiaoguang Allan Zhong, Plano, TX (US); Zachary Ryan Murphree, Dallas, TX (US)

(73) Assignee: Halliburton Energy Services, Inc., Houston, TX (US)

(21) Appl. No.: 14/429,836

(22) PCT Filed: Apr. 24, 2014
(86) PCT No.: PCT/US2014/035312

§ 371 Date: Mar. 20, 2015

(51) Int. Cl. C08G 75/045; E21B 23/01; E21B 33/12

(52) U.S. Cl. CPC C08G 75/045; E21B 33/12; E21B 23/01; E21B 33/128

(57) ABSTRACT

A degradable downhole tool or component thereof comprising a thiol-based polymer having at least one thiol functional group, wherein the thiol-based polymer is capable of at least partially degrading in a wellbore environment, thereby at least partially degrading the downhole tool or component thereof. The thiol-based polymer may be selected from the group consisting of a thiol-ene, a thiol-yne, a thiol-epoxy, and any combination thereof.

### BACKGROUND

The present disclosure generally relates to degradable downhole tools and components thereof and, more specifically, to downhole tools and components thereof comprising degradable thiol-based polymers that at least partially degrade upon exposure to a wellbore environment.

A variety of downhole tools may be used within a wellbore in connection with producing or reworking a hydrocarbon bearing subterranean formation. The downhole tool may comprise a wellbore isolation device capable of fluidly sealing two sections of the wellbore from one another and maintaining differential pressure (i.e., to isolate one pressure zone from another). The wellbore isolation device may be used in direct contact with the formation face of the wellbore, a tool string such as a casing string or a liner, with a screen or wire mesh, and the like.

After the production or reworking operation is complete, the seal formed by the downhole tool must be broken and the tool itself removed from the wellbore. The downhole tool must be removed to allow for production or further operations to proceed without being hindered by the presence of the downhole tool. Removal of the downhole tool(s) is traditionally accomplished by complex retrieval operations involving milling or drilling the downhole tool for mechanical retrieval. In order to facilitate such operations, downhole tools have traditionally been composed of drillable metal materials, such as cast iron, brass, or aluminum. These operations can be costly and time consuming, as they involve introducing a tool string into the wellbore, milling or drilling out the downhole tool (e.g., at least breaking the seal), and mechanically retrieving the downhole tool or pieces thereof from the wellbore and to the surface.

To reduce the cost and time required to mill or drill a downhole tool from a wellbore for its removal, dissolvable or degradable downhole tools have been developed. Traditionally, however, such dissolvable downhole tools have been designed only such that the dissolvable portion includes the tool mandrel itself and not any sealing element of the downhole tool. Moreover, traditional degradable tool bodies have been made of degradable polymers, degradable metals, or salts that have quasi static properties (i.e., that exhibit a particular physical state, such as rigidity or brittleness, without being otherwise adaptable). Additionally, traditional materials used for degrading the mandrel of a downhole tool involve complicated, time consuming, and expensive manufacturing processes.

### BRIEF DESCRIPTION OF THE DRAWINGS

The following figures are included to illustrate certain aspects of the embodiments, and should not be viewed as exclusive embodiments. The subject matter disclosed is capable of considerable modifications, alterations, combinations, and equivalents in form and function, as will occur to those skilled in the art and having the benefit of this disclosure.

FIG. 1 illustrates a cross-sectional view of a well system comprising a downhole tool, according to one or more embodiments described herein.

FIG. 2 depicts an enlarged cross-sectional view of a downhole tool, according to one or more embodiments described herein.

FIG. 3 shows an enlarged cross-sectional view of a downhole tool in operation, according to one or more embodiments described herein.

### DETAILED DESCRIPTION

The present disclosure generally relates to degradable downhole tools and components thereof and, more specifically, to downhole tools and components thereof comprising degradable thiol-based polymers that at least partially degrade upon exposure to a wellbore environment. As used herein, the term “thiol” is equivalent to the term “sulfhydryl.” As used herein, the term “degradable,” and all of its grammatical variants (e.g., “degrade,” “degradation,” “degrading,” and the like), refers to the process of or the ability to breaking down wholly or partially by any mechanism.

Disclosed are various embodiments of a degradable downhole tool or component thereof, including sealing elements capable of fluidly sealing two sections of a wellbore (which may also be referred to as “setting” the degradable downhole tool). The degradable downhole tool may have various setting mechanisms for fluidly sealing the sections of the wellbore with the sealing element including, but not limited to, hydraulic setting, mechanical setting, setting by swelling, setting by inflation, and the like. The degradable downhole tool or component thereof may be a well isolation device, such as a frac plug, a bridge plug, a packer, a wiper plug, a cement plug, or any other tool requiring a sealing element for use in a downhole operation. In some embodiments, the degradable downhole tool or component thereof may comprise a thiol-based polymer having at least one thiol functional group, wherein the thiol-based polymer is capable of at least partially degrading in a wellbore environment, thereby at least partially degrading the downhole tool or component thereof. In some embodiments, the entirety of the downhole tool may be made of the thiol-based polymer. In other embodiments, only a portion of the downhole tool may be made of the thiol-based polymer. Degradation of the thiol-based polymer forming at least a portion of the downhole tool or component thereof may occur in situ without the need to mill or drill and retrieve the downhole tool from the wellbore. In some cases, the downhole tool or component thereof may at least partially degrade such that it is no longer capable of isolating sections of the wellbore (i.e., it is not able to maintain a position in the wellbore) and may otherwise have portions that have not degraded, the non-degraded portions may drop into a rathole in the wellbore, for example, without the need for retrieval or may be sufficiently degraded in the wellbore so as to be generally indiscernible. It will be appreciated by one of skill in the art that while the embodiments herein are described with reference to a downhole tool, the degradable thiol-based polymers disclosed herein may be used with any wellbore operation equipment that may preferentially degrade upon exposure to a wellbore environment.

One or more illustrative embodiments disclosed herein are presented below. Not all features of an actual implementation are described or shown in this application for the sake of clarity. It is understood that in the development of an actual embodiment incorporating the embodiments disclosed herein, numerous implementation-specific decisions must be made to achieve the developer's goals, such as compliance with system-related, lithology-related, business-related, government-related, and other constraints, which vary by implementation and from time to time. While a developer's efforts might be complex and time-consuming, such efforts would be, nevertheless, a routine undertaking for those of ordinary skill in the art having the benefit of this disclosure.

It should be noted that when “about” is provided herein at the beginning of a numerical list, the term modifies each number of the numerical list. In some numerical listings of ranges, some lower limits listed may be greater than some upper limits listed. One skilled in the art will recognize that the selected subset will require the selection of an upper limit in excess of the selected lower limit. Unless otherwise indicated, all numbers expressed in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the exemplary embodiments described herein. At the very least, and not as an attempt to limit the application of the doctrine of equivalents to the scope of the claim, each numerical parameter should at least be construed in light of the number of reported significant digits and by applying ordinary rounding techniques.

While compositions and methods are described herein in terms of “comprising” various components or steps, the compositions and methods can also “consist essentially of” or “consist of” the various components and steps. When “comprising” is used in a claim, it is open-ended.

The use of directional terms such as above, below, upper, lower, upward, downward, left, right, uphole, downhole and the like are used in relation to the illustrative embodiments as they are depicted in the figures, the upward direction being toward the top of the corresponding figure and the downward direction being toward the bottom of the corresponding figure, the uphole direction being toward the surface of the well and the downhole direction being toward the toe of the well.

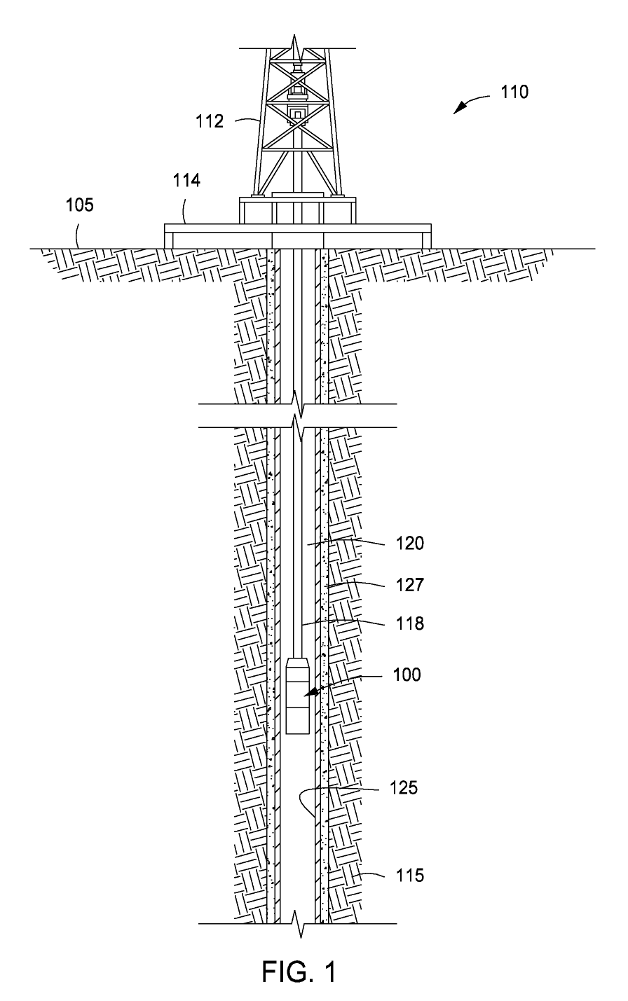

Referring now to FIG. 1, illustrated is an exemplary well system 110 for a downhole tool 100. As depicted, a derrick 112 with a rig floor 114 is positioned on the earth's surface 105. A wellbore 120 is positioned below the derrick 112 and the rig floor 114 and extends into subterranean formation 115. As shown, the wellbore may be lined with casing 125 that is cemented into place with cement 127. It will be appreciated that although FIG. 1 depicts the wellbore 120 having a casing 125 being cemented into place with cement 127, the wellbore 120 may be wholly or partially cased and wholly or partially cemented (i.e., the casing wholly or partially span the wellbore and may or may not be wholly or partially cemented in place), without departing from the scope of the present disclosure. Moreover, the wellbore 120 may be an open-hole wellbore. A tool string 118 extends from the derrick 112 and the rig floor 114 downwardly into the wellbore 120. The tool string 118 may be any mechanical connection to the surface, such as, for example, wireline, slickline, jointed pipe, or coiled tubing. As depicted, the tool string 118 suspends the downhole tool 100 for placement into the wellbore 120 at a desired location to perform a specific downhole operation. As previously mentioned, the down hole tool 100 may be any type of wellbore isolation device including, but not limited to, a frac plug, a bridge plug, a packer, a wiper plug, or a cement plug.

It will be appreciated by one of skill in the art that the well system 110 of FIG. 1 is merely one example of a wide variety of well systems in which the principles of the present disclosure may be utilized. Accordingly, it will be appreciated that the principles of this disclosure are not necessarily limited to any of the details of the depicted well system 110, or the various components thereof, depicted in the drawings or otherwise described herein. For example, it is not necessary in keeping with the principles of this disclosure for the wellbore 120 to include a generally vertical cased section. The well system 110 may equally be employed in vertical and/or deviated wellbores, without departing from the scope of the present disclosure. Furthermore, it is not necessary for a single downhole tool 100 to be suspended from the tool string 118.

In addition, it is not necessary for the downhole tool 100 to be lowered into the wellbore 120 using the derrick 112. Rather, any other type of device suitable for lowering the downhole tool 100 into the wellbore 120 for placement at a desired location may be utilized without departing from the scope of the present disclosure such as, for example, mobile workover rigs, well servicing units, and the like. Although not depicted, the downhole tool 100 may alternatively be hydraulically pumped into the wellbore and, thus, not need the tool string 118 for delivery into the wellbore 120.

Although not depicted, the structure of the downhole tool 100 may take on a variety of forms to provide fluid sealing between two wellbore sections. Generally, the downhole tool 100, regardless of its specific structure as a specific type of wellbore isolation device, may have one or more components thereof. In some embodiments, the component of the downhole tool may include, but is not limited to, a sealing element, a spacer ring, a slip, a wedge, a retainer ring, an extrusion limiter, an o-ring, a backup shoe, a mule shoe, a tapered shoe, a flapper, a ball, a ball seat, a sleeve, a cage, a fluid enclosure, and any combination thereof. The downhole tool 100 and component thereof may be comprised of the same material or, as is generally the case, certain components of the downhole tool 100 may be of a material to lend rigidity thereto (e.g., a main mandrel of the downhole tool) and other components may be of a material to lead elasticity or residency thereto (e.g., a sealing element). For illustrative purposes, the downhole tool 100 may be described herein as having a mandrel and a sealing element. Both the mandrel and the sealing element may be considered “components” of the downhole tool 100, and each may be comprised of one or more degradable thiol-based polymers. Although the downhole tool 100 is described herein for illustrative purposes as having a mandrel and a sealing element, it will be appreciated that any number of other components may also form a portion of the downhole tool 100 including, but not limited to, those listed above, without departing from the scope of the present disclosure.

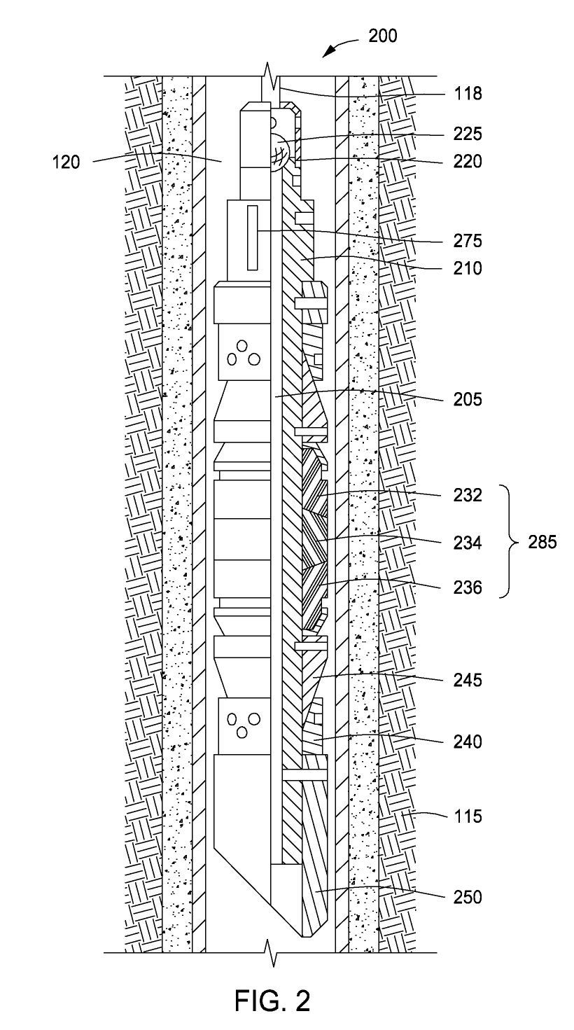

Referring now to FIG. 2, with continued reference to FIG. 1, one specific type of downhole tool described herein is a frac plug wellbore isolation device for use during a well stimulation/fracturing operation. FIG. 2 illustrates a cross-sectional view of an exemplary frac plug 200 being lowered into a wellbore 120 on a tool string 118. As previously mentioned, the frac plug 200 may comprise a mandrel 210 and a sealing element 285. The sealing element 285, as depicted, comprises an upper sealing element 232, a center sealing element 234, and a lower sealing element 236. It will be appreciated that although the sealing element 285 is shown as having three portions (i.e., the upper sealing element 232, the center sealing element 234, and the lower sealing element 236), any other number of portions, or a single portion, may also be employed without departing from the scope of the present disclosure.

As depicted, the sealing element 285 is extending around the mandrel 210; however, it may be of any other configuration suitable for allowing the sealing element 285 to form a fluid seal in the wellbore 120, without departing from the scope of the present disclosure. For example, in some embodiments, the mandrel may comprise two sections joined together by the sealing element, such that the two sections of the mandrel compress to permit the sealing element to make a fluid seal in the wellbore 120. Other such configurations are also suitable for use in the embodiments described herein. Moreover, although the sealing element 285 is depicted as located in a center section of the mandrel 210, it will be appreciated that it may be located at any location along the length of the mandrel 210, without departing from the scope of the present disclosure.

The mandrel 210 of the frac plug 200 comprises an axial flowbore 205 extending therethrough. A cage 220 is formed at the upper end of the mandrel 210 for retaining a ball 225 that acts as a one-way check valve. In particular, the ball 225 seals off the flowbore 205 to prevent flow downwardly therethrough, but permits flow upwardly through the flowbore 205. One or more slips 240 are mounted around the mandrel 210 below the sealing element 285. The slips 240 are guided by a mechanical mandrel slip 245. A tapered shoe 250 is provided at the lower end of the mandrel 210 for guiding and protecting the frac plug 200 as it is lowered into the wellbore 120. An optional enclosure 275 for storing a chemical solution may also be mounted on the mandrel 210 or may be formed integrally therein. In one embodiment, the enclosure 275 is formed of a frangible material.

One or both of the mandrel 210 and the sealing element 285, or any other component of the downhole tool 100 (FIG. 1) or the frac plug 200, may comprise a degradable thiol-based polymer in an amount sufficient to at least partially degrade the tool or component thereof. The thiol-based polymer may comprise at least one thiol functional group. In some embodiments, the thiol-based polymer may comprise thiol functional groups in the range of from a lower limit of about 1, 2, 3, 4, 5, 6, 7, 8, 9, 10, and 11 to an upper limit of about 22, 21, 20, 19, 18, 17, 16, 15, 14, 13, 12, and 11. In other embodiments, the thiol-based polymer may comprise even a greater number of thiol functional groups.

The thiol-based polymer may be, but is not limited to, a thiol-ene reaction product, a thiol-yne reaction product, a thiol-epoxy reaction product, and any combination thereof. The thiol-based polymers, whether the reaction product of thiol-ene, thiol-yne, or thiol-epoxy, may be referred to herein as generally being the reaction product of a thiol functional group and an unsaturated functional group. The thiol functional group is an organosulfur compound that contains a carbon-bonded sulfhydryl, represented by the formula —C—SH or R—SH, where R represents an alkane, alkene, or other carbon-containing group of atoms.

The thiol-based polymers described herein may be formed by click chemistry. As used herein, the term “click chemistry,” and grammatical variants thereof, refers to a chemical reaction of generating substances by joining small modular units. Click chemistry results in the formation of such substances quickly and reliably. That is, the reactions are efficient, high yielding, and tolerant of various solvents and functional groups. In some embodiments, the click chemistry may be capable of forming the thiol-based polymers described herein in less than about 30 minutes. In other embodiments, the click chemistry may be capable of forming the thiol-based polymers described herein in less than about 25 minutes, 20 minutes, 15 minutes, 10 minutes, and 5 minutes. Accordingly, the thiol-based polymers described herein may be formed easily for use in a downhole tool 100 (FIG. 1) or component thereof, thereby reducing associated costs.

The thiol-ene reaction product may be formed by click chemistry by the addition of a S—H bond across a double or triple bond by either a free radical or ionic mechanism. Thiol-ene reactions may be characterized as the sulfur version of a hydrosilylation reaction. The thiol-ene reaction product may be formed by the reaction of at least one thiol functional group with a variety of unsaturated functional groups including, but not limited to, a maleimide, an acrylate, a norborene, a carbon-carbon double bond, a silane, a Michael-type nucleophilic addition, and any combination thereof. As used herein, the term “Michael-type nucleophilic addition,” and grammatical variants thereof, refers to the nucleophilic addition of a carbanion or another nucleophile to an α,β-unsaturated carbonyl compound, having the general structure (O═C)—C^{α}═C^{β}—. An example of a suitable thiol-ene reaction produce may include, but is not limited to, 1,3,5,-triacryloylhexahydro-1,3,5-triazine. Examples of suitable thiol-ene/silane reaction products that may be used in forming at least a portion of the downhole tool 100 (FIG. 1) or component thereof include, but are not limited to, the following Formulas 1-6:

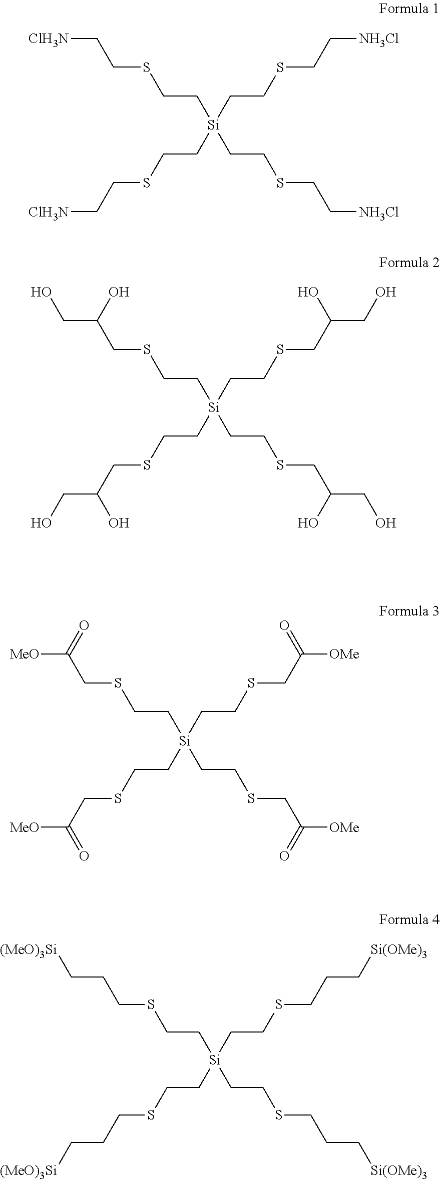

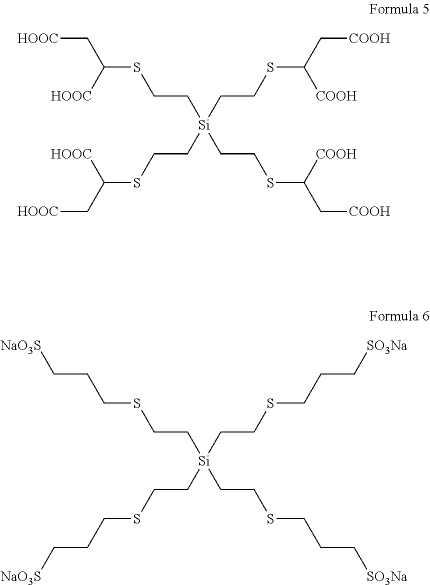

The thiol-yne reaction products may be characterized by an organic addition reaction between a thiol functional group and an alkyne, the alkyne being an unsaturated hydrocarbon having at least one carbon-carbon triple bond. The addition reaction may be facilitated by a radical initiator or UV irradiation and proceeds through a sulfanyl radical species. The reaction may also be amine-mediated, or transition-metal catalyzed.

The thiol-epoxy reaction products may be prepared by a thiol-ene reaction with at least one epoxide functional group. Suitable epoxide functional groups may include, but are not limited to, a glycidyl ether, a glycidyl amine, or as part of an aliphatic ring system. Specific examples of epoxide functional groups may include, but are not limited to, bisphenol-A diglycidyl ether, triglycidylisocyanurate, trimethylolpropane triglycidyl ether, and any combination thereof. The thiol-epoxy reaction products may proceed by one or more of the mechanisms presented below; however, other mechanisms may also be used without departing from the scope of the present disclosure:

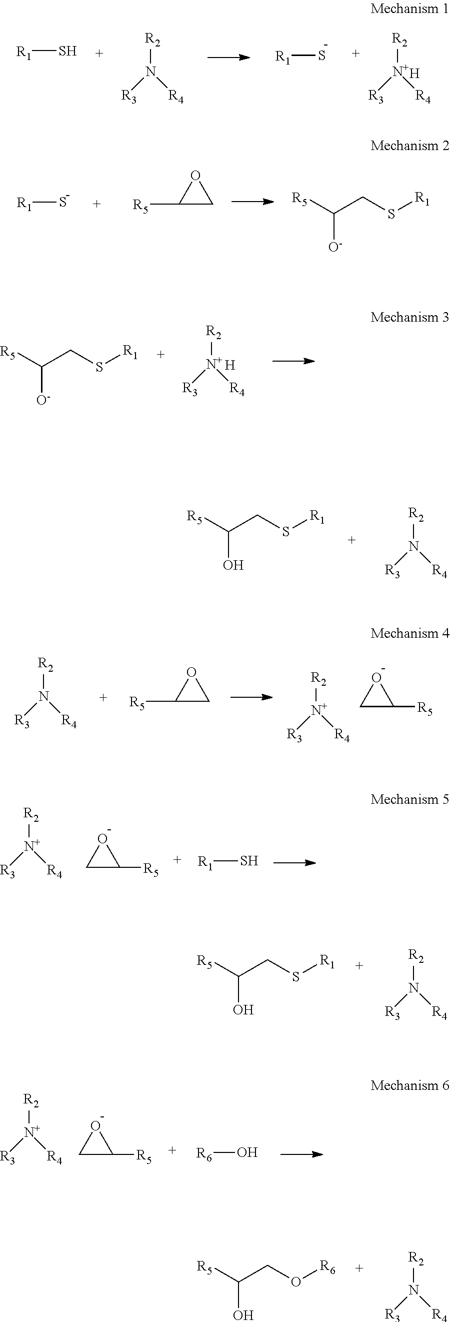

Polymers generally have a glass transition temperature. As used herein, the term “glass transition temperature” refers to the reversible transition of a polymer from a hard and relatively brittle (or “rigid”) state to a molten or rubber-like (“resilient”) state. The glass transition temperature is represented by a temperature range, in which the mechanical properties of the polymer change. The thiol-based polymers described herein are particularly beneficial in forming at least a portion of the downhole tool 100 (FIG. 1) or component thereof, as described in the present disclosure, because they exhibit glass transition temperature ranges that are particularly narrow. Accordingly, the shift between mechanical properties may be particularly sharp, and reliably dependent of a narrow temperature range. Furthermore, not only may the thiol-based polymers have a narrow glass transition temperature range, they may be beneficially composed to be degradable, thus allowing them to form a portion of the degradable downhole tool 100 or component thereof in the embodiments described herein. The glass transition temperature of the thiol-based polymers may be dependent on the chemical make-up of the polymer and, thus, can be adjusted by varying the chemical make-up of the polymer (e.g., by changing the type, number, or combination of functional groups, for example). At temperatures above the glass transition, the thiol-based polymer may exhibit resilient or rubber-like characteristics, and at temperatures below the glass transition, the thiol-based polymer may exhibit rigid or structurally-sturdy characteristics. Accordingly, because the thiol-based polymers each have a specific glass transition temperature, the downhole tool 100 (FIG. 1) or component thereof may be comprised of more than one thiol-based polymer, where at a particular temperature, certain thiol-based polymers exhibit the rigid characteristic (e.g., for forming at least a portion of the mandrel) and certain other thiol-based polymers exhibit a resilient characteristic (e.g., for forming at least a portion of the sealing element). In other embodiments, the thiol-based polymer may exhibit the rigid characteristic both above and below the glass transition temperature, but would have different rates of degradation above the glass transition temperature as compared to below the glass transition temperature. As such, each and every component of the downhole tool 100 could comprise a thiol-based polymer, adjusted compositionally to exhibit either the rigid or resilient characteristic (such as based on the temperature of the subterranean formation) and to have a particular degradation rate or range. The selection of the thiol-based polymers for forming the downhole tool 100 or component thereof may depend on a number of factors, but may be particularly dependent on the temperature of the subterranean formation at the time the downhole tool 100 is placed therein and overtime as an operation is performed and hydrocarbon production begins.

The thiol-based polymers may at least partially degrade over time in the wellbore environment, such as by exposure to an aqueous fluid, a hydrocarbon fluid, and/or elevated temperatures. In some embodiments, the degradation rate of the thiol-based polymer may be accelerated at elevated temperatures above the glass transition temperature of the particular polymer. For example, as the thiol-based polymer is exposed to elevated downhole temperatures, the mechanical properties of the polymer change and the degradation rate accelerates, as compared to the degradation rate below the glass transition temperature.

Referring back to FIG. 1, the downhole tool 100 or component thereof may be at least partially composed of a thiol-based polymer, the thiol-based polymer being formed of at least one thiol functional group and a degradable functional group. The degradable functional group may degrade, at least in part, in the presence of an aqueous fluid (e.g., a treatment fluid), a hydrocarbon fluid (e.g., a produced fluid in the formation), an elevated temperature, and any combination thereof. That is, the thiol-based polymer forming the downhole tool 100 or component thereof may itself degrade, as well as the degradable functional group forming a portion of the thiol-based polymer. Moreover, the mechanism by which the thiol-polymer itself or the degradable functional group degrades may be different or the same. The aqueous fluid may be any aqueous fluid present in the wellbore environment including, but not limited to, fresh water, saltwater (e.g., water containing one or more salts dissolved therein), brine (e.g., saturated salt water), seawater, or combinations thereof. Accordingly, the aqueous fluid may comprise ionic salts. The aqueous fluid may come from the wellbore 120 itself (i.e., the subterranean formation) or may be introduced by a wellbore operator. The hydrocarbon fluid may include, but is not limited to, crude oil, a fractional distillate of crude oil, a fatty derivative of an acid, an ester, an ether, an alcohol, an amine, an amide, or an imide, a saturated hydrocarbon, an unsaturated hydrocarbon, a branched hydrocarbon, a cyclic hydrocarbon, and any combination thereof. The elevated temperature may be above the glass transition temperature of the thiol-based polymer or, in the case of a degradable functional group, may be a temperature greater than about 60° C. (140° F.).

The thiol-based polymer forming at least a portion of the frac plug 200 or component thereof, as described herein, may degrade by a number of mechanisms. For example, the thiol-based polymer may degrade by swelling, dissolving, undergoing a chemical change, undergoing thermal degradation in combination with any of the foregoing, and any combination thereof. Degradation by swelling involves the absorption by the thiol-based polymer of a fluid in the wellbore environment such that the mechanical properties of the polymer degrade. In one embodiment, the thiol-based polymer continues to absorb the fluid until its mechanical properties are no longer capable of maintaining their integrity. In some embodiments, the thiol-based polymer may be designed to only partially degrade by swelling in order to ensure that the mechanical properties of the downhole tool 100 or component thereof comprising the thiol-based polymer is sufficiently capable of lasting for the duration of the specific operation in which it is utilized. Degradation by dissolving may involve use of a thiol-based polymer that is at least partially soluble or otherwise susceptible to a fluid in the formation (e.g., an aqueous fluid or a hydrocarbon fluid), such that the fluid is not necessarily incorporated into the polymer (as is the case with degradation by swelling), but becomes soluble upon contact with the fluid. Degradation by undergoing a chemical change may involve breaking the bonds of the backbone of the thiol-based polymer (i.e., polymer backbone), breaking crosslinks in the thiol-based polymer, or causing the bonds of the thiol-based polymer to crosslink, such that it becomes becomes brittle and breaks into small pieces upon contact with even small forces expected in the wellbore environment. Thermal degradation of the thiol-based polymer may involve a chemical decomposition due to heat, such as the heat present in a wellbore environment, which may be above about 50° C. (122° F.).

In preferred embodiments, as mentioned above, the thiol-based polymer may comprise at least one thiol functional group and at least one degradable functional group. Such degradable functional groups may include, but are not limited to, one or more of a degradable monomer, a degradable oligomer, or a degradable polymer. Specific examples of degradable functional groups may include, but are not limited to, an acrylate, a lactide, a lactone, a glycolide, an anhydride, a lactam, an allyl, a polyethylene glycol, a polyethylene glycol-based hydrogel, an aerogel, a poly(lactide), a poly(glycolic acid), a poly(vinyl alcohol), a poly(N-isopropylacrylamide), a poly(ε-caprolactone, a poly(hydroxybutyrate), a polyanhydride, an aliphatic polycarbonate, an aromatic polycarbonate, a poly(orthoester), a poly(hydroxyl ester ether), a poly(orthoester), a poly(amino acid), a poly(ethylene oxide), a polyphosphazene, a poly(phenyllactide), a poly(hydroxybutyrate), a dextran, a chitin, a cellulose, a protein, an aliphatic polyester, and any combination thereof.

In some embodiments, the degradable functional group may be particular susceptible to degradation by swelling. In such cases, the thiol-based polymer comprising the degradable functional group may be particularly beneficial for use in forming a portion of the downhole tool 100 that requires swelling for its normal use (e.g., the sealing element). For example, in a preferred embodiment, the thiol-based polymer comprises at least one polyethylene glycol-based hydrogel, such as one formed by a four-arm polyethylene glycol norbornene that is crosslinked with dithiol containing crosslinkers to form a chemically crosslinked hydrogel. The swelling properties of such a hydrogel may vary depending on a number of factors including, but not limited to, network density, the degree of crosslinking, and any combination thereof. In some preferred embodiments, the degree of crosslinking may be desirably increased in order to achieve a higher tensile modulus and reduced swelling percentage.

The degradation rate of the downhole tool 100 or component thereof may be in the range of from a lower limit of about 30 minutes, 1 hour, 5 hours, 10 hours, 15 hours, 20 hours, 1 day, and 5 days to an upper limit of about 40 days, 35 days, 30 days, 25 days, 20 days, 15 days, 10 days, and 5 days, encompassing any value or subset therebetween.

In some embodiments, the thiol-based polymer may further comprise a reinforcing material selected from the group consisting of a particulate, a fiber, a fiber weave, and any combination thereof. The reinforcing material may increase the strength, stiffness, or salt creep resistance of the thiol-based polymer and, thus, the downhole tool 100 or component thereof, as needed for a particular downhole operation. The particulate may be of any size suitable for embedding in the thiol-based polymer, such as between a lower limit of about 400 mesh, 380 mesh, 360 mesh, 340 mesh, 320 mesh, 300 mesh, 280 mesh, 260 mesh, 240 mesh, and 220 mesh to an upper limit of about 40 mesh, 60 mesh, 80 mesh, 100 mesh, 120 mesh, 140 mesh, 160 mesh, 180 mesh, 200 mesh, and 220 mesh, U.S. Sieve Series, and encompassing any value or subset therebetween. Moreover, there is no need for the particulates to be sieved or screened to a particular or specific particle mesh size or particular particle size distribution, but rather a wide or broad particle size distribution can be used, although a narrow particle size distribution is also suitable.

In some embodiments, the particulates may be substantially spherical or non-spherical. Substantially non-spherical proppant particulates may be cubic, polygonal, or any other non-spherical shape. Such substantially non-spherical particulates may be, for example, cubic-shaped, rectangular-shaped, rod-shaped, ellipse-shaped, cone-shaped, pyramid-shaped, planar-shaped, oblate-shaped, or cylinder-shaped. That is, in embodiments wherein the particulates are substantially non-spherical, the aspect ratio of the material may range such that the material is planar to such that it is cubic, octagonal, or any other configuration.

Particulates suitable for use in the embodiments described herein may comprise any material suitable for use in the thiol-based polymer that provides one or more of stiffness, strength, or creep resistance, or any other added benefit. Suitable materials for these particulates may include, but are not limited to, sand, bauxite, ceramic materials, glass materials, polymer materials (e.g., ethylene vinyl acetate or composite materials), polytetrafluoroethylene materials, nut shell pieces, cured resinous particulates comprising nut shell pieces, seed shell pieces, cured resinous particulates comprising seed shell pieces, fruit pit pieces, cured resinous particulates comprising fruit pit pieces, wood, composite particulates, and combinations thereof. Suitable composite particulates may comprise a binder and a filler material wherein suitable filler materials include silica, alumina, fumed carbon, carbon black, graphite, mica, titanium dioxide, barite, meta-silicate, calcium silicate, kaolin, talc, zirconia, boron, fly ash, hollow glass microspheres, solid glass, and combinations thereof.

The fibers for use in the thiol-based polymer may be of any size and material capable of being included in the polymer. In some embodiments, the fibers may have a length of less than about 1.25 inches and a width of less than about 0.01 inches. In some embodiments, a mixture of different sizes of fibers may be used. Suitable fibers may be formed from any material suitable for use as a particulate, as described previously, as well as materials including, but not limited to, carbon fibers, carbon nanotubes, graphene, fullerene, a ceramic fiber, a plastic fiber, a glass fiber, a metal fiber, and any combination thereof. In some embodiments, the fibers may be woven together to form a fiber weave for use in the thiol-based polymer.

In some embodiments, the degradable functional group in the thiol-based polymer forming at least a portion of the downhole tool 100 or component thereof may release an accelerant during degradation that accelerates the degradation of the thiol-based polymer. In some cases, the accelerant is a natural component that is released upon degradation of the degradable functional element, such as an acid (e.g., release of an acid upon degradation of a poly(lactide) functional group). Similarly, the degradable functional group may release a base that would aid in degrading the thiol-based polymer (and thus the downhole tool 100 or component thereof). In other embodiments, the accelerant need not be the degradable functional group, but may be embedded in the thiol-based polymer or any other portion of the downhole tool 100 or component thereof that is not formed by the thiol-based polymer. The accelerant may be in any form, including a solid or a liquid.

Suitable accelerants may include, but are not limited to, a chemical, a crosslinker, sulfur, a sulfur releasing agent, a peroxide, a peroxide releasing agent, a catalyst, an acid releasing agent, a base releasing agent, and any combination thereof. In some embodiments, the accelerant may cause the thiol-based polymer in the downhole tool 100 or component thereof to become brittle to aid in degradation. Specific accelerants may include, but are not limited to, a polylactide, a polyglycolide, an ester, a cyclic ester, a diester, an anhydride, a lactone, an amide, an anhydride, an alkali metal alkoxide, a carbonate, a bicarbonate, an alcohol, an alkali metal hydroxide, ammonium hydroxide, sodium hydroxide, potassium hydroxide, an amine, an alkanol amine, an acid (e.g., hydrochloric acid, hydrofluoric acid, ammonium bifluoride, formic acid, acetic acid, lactic acid, glycolic acid, aminopolycarboxylic acid, polyaminopolycarbocylic acid, organic acids, and the like), and any combination thereof.

The accelerant, when embedded in the thiol-based polymer or other portion of the downhole tool 100 or component thereof, may be present in the range of from a lower limit of about 0.1%, 1%, 5%, 10%, 15%, 20%, and 25%, to an upper limit of about 60%, 55%, 50%, 45%, 40%, 35%, 30%, and 25% by weight of the thiol-based polymer forming the downhole tool 100 or component thereof, and encompassing any value or subset therebetween.

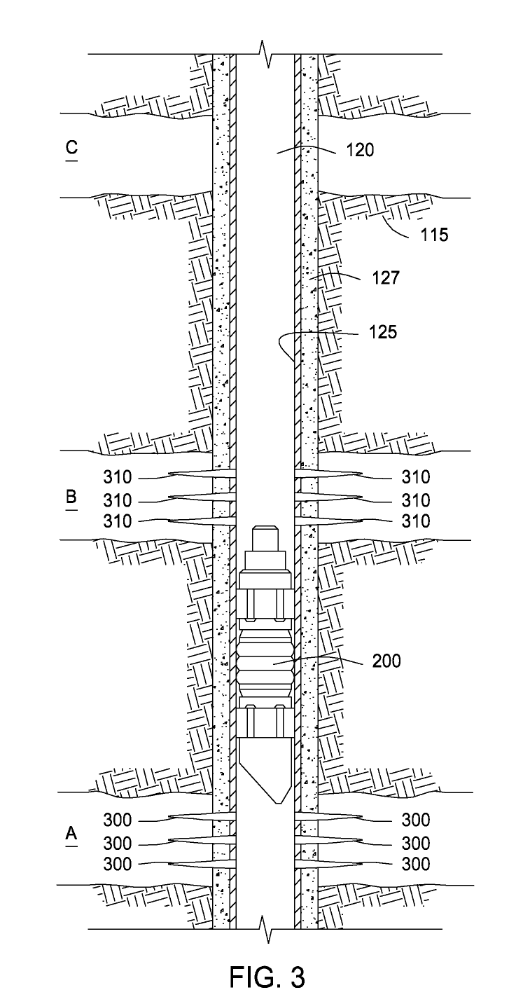

Referring again to FIG. 2, in operation the frac plug 200 may be used in a downhole fracturing operation to isolate a zone of the formation 115 below the plug 200. Referring now to FIG. 3, with continued reference to FIG. 2, the frac plug 200 is shown disposed between producing zone A and producing zone B in formation 115. In a conventional fracturing operation, before setting the frac plug 200 to isolate zone A from zone B, a plurality of perforations 300 are made by a perforating tool (not shown) through the casing 125 and cement 127 to extend into producing zone A. Then a well stimulation fluid is introduced into the wellbore 120, such as by lowering a tool (not shown) into the wellbore 120 for discharging the fluid at a relatively high pressure or by pumping the fluid directly from the derrick 112 (FIG. 1) into the wellbore 120. The well stimulation fluid passes through the perforations 300 into producing zone A of the formation 115 for stimulating the recovery of fluids in the form of oil and gas containing hydrocarbons. These production fluids pass from zone A, through the perforations 300, and up the wellbore 120 for recovery at the surface 105 (FIG. 1).

The frac plug 200 is then lowered by the tool string 118 (FIG. 1) to the desired depth within the wellbore 120, and the sealing element 285 (FIG. 2) is set against the casing 125, thereby isolating zone A as depicted in FIG. 3. Due to the design of the frac plug 200, the flowbore 205 (FIG. 2) of the frac plug 200 allows fluid from isolated zone A to flow upwardly through the frac plug 200 while preventing flow downwardly into the isolated zone A. Accordingly, the production fluids from zone A continue to pass through the perforations 300, into the wellbore 120, and upwardly through the flowbore 205 of the frac plug 200, before flowing into the wellbore 120 above the frac plug 200 for recovery at the surface 105.

After the frac plug 200 is set into position, as shown in FIG. 3, a second set of perforations 310 may then be formed through the casing 125 and cement 127 adjacent intermediate producing zone B of the formation 115. Zone B is then treated with well stimulation fluid, causing the recovered fluids from zone B to pass through the perforations 310 into the wellbore 120. In this area of the wellbore 120 above the frac plug 200, the recovered fluids from zone B will mix with the recovered fluids from zone A before flowing upwardly within the wellbore 120 for recovery at the surface 105.

If additional fracturing operations will be performed, such as recovering hydrocarbons from zone C, additional frac plugs 200 may be installed within the wellbore 120 to isolate each zone of the formation 115. Each frac plug 200 allows fluid to flow upwardly therethrough from the lowermost zone A to the uppermost zone C of the formation 115, but pressurized fluid cannot flow downwardly through the frac plug 200.

After the fluid recovery operations are complete, the frac plug 200 must be removed from the wellbore 120. In this context, as stated above, at least a portion of the frac plug 200 may degrade by exposure to the wellbore environment. Accordingly, in an embodiment, the frac plug 200 is designed to decompose over time while operating in a wellbore environment, thereby eliminating the need to mill or drill the frac plug 200 out of the wellbore 120. Thus, by exposing the frac plug 200 to the wellbore environment over time, the thiol-based polymer will decompose, causing the frac plug 200 to lose structural and/or functional integrity and release from the casing 125. The remaining components of the plug 200 may simply fall to the bottom of the wellbore 120. In various alternate embodiments, degrading one or more components of a downhole tool 100 (FIG. 1) may perform an actuation function, open a passage, release a retained member, or otherwise change the operating mode of the downhole tool 100.

Referring again to FIG. 1, removing the downhole tool 100, described herein from the wellbore 120 is more cost effective and less time consuming than removing conventional downhole tools, which require making one or more trips into the wellbore 120 with a mill or drill to gradually grind or cut the tool away. Instead, the downhole tools 100 described herein are removable by simply exposing the tools 100 to a naturally occurring downhole environment over time. The foregoing descriptions of specific embodiments of the downhole tool 100, and the systems and methods for removing the biodegradable tool 100 from the wellbore 120 have been presented for purposes of illustration and description and are not intended to be exhaustive or to limit this disclosure to the precise forms disclosed. Many other modifications and variations are possible. In particular, the type of downhole tool 100, or the particular components that make up the downhole tool 100 (e.g., the mandrel and sealing element) may be varied. For example, instead of a frac plug 200 (FIG. 2), the downhole tool 100 may comprise a bridge plug, which is designed to seal the wellbore 120 and isolate the zones above and below the bridge plug, allowing no fluid communication in either direction. Alternatively, the downhole tool 100 could comprise a packer that includes a shiftable valve such that the packer may perform like a bridge plug to isolate two formation zones, or the shiftable valve may be opened to enable fluid communication therethrough. Similarly, the downhole tool 100 could comprise a wiper plug or a cement plug.

While various embodiments have been shown and described herein, modifications may be made by one skilled in the art without departing from the scope of the present disclosure. The embodiments described here are exemplary only, and are not intended to be limiting. Many variations, combinations, and modifications of the embodiments disclosed herein are possible and are within the scope of the disclosure. Accordingly, the scope of protection is not limited by the description set out above, but is defined by the claims which follow, that scope including all equivalents of the subject matter of the claims.

Embodiments disclosed herein include Embodiment A, Embodiment B, and Embodiment C.

### Embodiment A

A degradable downhole tool or component thereof comprising a thiol-based polymer having at least one thiol functional group, wherein the thiol-based polymer is capable of at least partially degrading in a wellbore environment, thereby at least partially degrading the downhole tool or component thereof.

Embodiment A may have one or more of the following additional elements in any combination:

Element A1: Wherein the thiol-based polymer comprises between about 1 and about 22 thiol functional groups.

Element A2: Wherein the thiol-based polymer is selected from the group consisting of a thiol-ene reaction product, a thiol-yne reaction product, a thiol-epoxy reaction product, and any combination thereof.

Element A3: Wherein the thiol-based polymer further comprises at least one of a degradable functional group comprising one or more of a degradable monomer, a degradable oligomer, and a degradable polymer.

Element A4: Wherein the degradable functional group is selected from the group consisting of an acrylate, a lactide, a lactone, a glycolide, an anhydride, a lactam, an allyl, a polyethylene glycol, a polyethylene glycol-based hydrogel, an aerogel, a poly(lactide), a poly(glycolic acid), a poly(vinyl alcohol), a poly(N-isopropylacrylamide), a poly(ε-caprolactone, a poly(hydroxybutyrate), a polyanhydride, an aliphatic polycarbonate, an aromatic polycarbonate, a poly(orthoester), a poly(hydroxyl ester ether), a poly(orthoester), a poly(amino acid), a poly(ethylene oxide), a polyphosphazene, a poly(phenyllactide), a poly(hydroxybutyrate), a dextran, a chitin, a cellulose, a protein, an aliphatic polyester, and any combination thereof.

Element A5: Wherein the thiol-based polymer has a glass transition temperature and exhibits a resilient characteristic above the glass transition temperature and a rigid characteristic below the glass transition temperature, and wherein the downhole tool or component thereof comprises the at least one thiol-based polymer having the resilient characteristic, the rigid characteristic, or any combination thereof.

Element A6: Wherein the thiol-based polymer further comprises a reinforcing material selected from the group consisting of a particulate, a fiber, a fiber weave, and any combination thereof.

Element A7: Wherein the downhole tool comprises a wellbore isolation device.

Element A8: Wherein the downhole tool comprises a wellbore isolation device selected from the group consisting of a mandrel, a ball, a plug, a wiper, a sealing element, a spacer ring, a slip, a wedge, a retainer ring, an extrusion limiter, an o-ring, a backup shoe, a mule shoe, a tapered shoe, a flapper, a ball seat, a sleeve, a cage, a fluid enclosure, and any combination thereof.

By way of non-limiting example, exemplary combinations applicable to Embodiment A include: A1 and A2; A1 and A3; A1, A2, and A3; A2 and A4; A2 and A5; A4 and A6; A6, A7, and A8.

### Embodiment B

A method comprising: providing a downhole tool, wherein the downhole tool or a component thereof comprises a thiol-based polymer, and wherein the thiol-based polymer is capable of at least partially degrading in a wellbore environment, thereby at least partially degrading the downhole tool or component thereof; introducing the downhole tool into the wellbore; performing a downhole operation; and at least partially degrading the downhole tool or component thereof in the wellbore.

Embodiment B may have one or more of the following additional elements in any combination:

Element B1: Further comprises removing the degraded downhole tool or component thereof from the wellbore.

Element B2: Wherein the thiol-based polymer comprises between about 1 and about 22 thiol functional groups.

Element B3: Wherein the thiol-based polymer is selected from the group consisting of a thiol-ene reaction product, a thiol-yne reaction product, a thiol-epoxy reaction product, and any combination thereof.

Element B4: Wherein the thiol-based polymer further comprises at least one of a degradable functional group comprising one or more of a degradable monomer, a degradable oligomer, and a degradable polymer.

Element B5: Wherein the thiol-based polymer has a glass transition temperature and exhibits a resilient characteristic above the glass transition temperature and a rigid characteristic below the glass transition temperature, and wherein the downhole tool or component thereof comprises the at least one thiol-based polymer having the resilient characteristic, the rigid characteristic, or any combination thereof.

Element B6: Wherein the thiol-based polymer further comprises a reinforcing material selected from the group consisting of a particulate, a fiber, a fiber weave, and any combination thereof.

Element B7: Wherein the downhole tool comprises a wellbore isolation device.

Element B8: Wherein the downhole tool comprises a wellbore isolation device selected from the group consisting of a mandrel, a ball, a plug, a wiper, a sealing element, a spacer ring, a slip, a wedge, a retainer ring, an extrusion limiter, an o-ring, a backup shoe, a mule shoe, a tapered shoe, a flapper, a ball seat, a sleeve, a cage, a fluid enclosure, and any combination thereof.

By way of non-limiting example, exemplary combinations applicable to Embodiment B include: combinations of B1 and B2; B2 and B3; B1, B2, and B3; B1, B2, and B4; B1, B2, and B5; B1 and B6; B1 and B7; B2 and B6; B2 and B7; B2, B3, B7, and B9.

### Embodiment C

A system comprising: a wellbore; and a downhole tool capable of being disposed in the wellbore to perform a downhole operation, the downhole tool or a component thereof comprising a thiol-based polymer having at least one thiol functional group, and wherein the thiol-based polymer is capable of at least partially degrading in the wellbore environment, thereby at least partially degrading the downhole tool or component thereof.

Embodiment C may have one or more of the following additional elements in any combination:

Element C1: Wherein the thiol-based polymer comprises between about 1 and about 22 thiol functional groups.

Element C2: Wherein the thiol-based polymer is selected from the group consisting of a thiol-ene reaction product, a thiol-yne reaction product, a thiol-epoxy reaction product, and any combination thereof.

Element C3: Wherein the thiol-based polymer further comprises at least one of a degradable functional group comprising one or more of a degradable monomer, a degradable oligomer, and a degradable polymer.

Element C4: Wherein the thiol-based polymer has a glass transition temperature and exhibits a resilient characteristic above the glass transition temperature and a rigid characteristic below the glass transition temperature, and wherein the downhole tool or component thereof comprises the at least one thiol-based polymer having the resilient characteristic, the rigid characteristic, or any combination thereof.

Element C5: Wherein the thiol-based polymer further comprises a reinforcing material selected from the group consisting of a particulate, a fiber, a fiber weave, and any combination thereof.

Element C6: Wherein the downhole tool comprises a wellbore isolation device.

Element C7: Wherein the downhole tool comprises a wellbore isolation device selected from the group consisting of a mandrel, a ball, a plug, a wiper, a sealing element, a spacer ring, a slip, a wedge, a retainer ring, an extrusion limiter, an o-ring, a backup shoe, a mule shoe, a tapered shoe, a flapper, a ball seat, a sleeve, a cage, a fluid enclosure, and any combination thereof.

By way of non-limiting example, exemplary combinations applicable to Embodiment C include: C1 and C2; C2 and C3; C1, C2, and C3; C1, C2, and C4; C1, C2, and C5; C1 and C6; C1 and C7; C2 and C6; C2 and C7.

To facilitate a better understanding of the embodiments of the present invention, the following examples of preferred or representative embodiments are given. In no way should the following example be read to limit, or to define, the scope of the invention.

### EXAMPLE

A thiol-based polymer was designed using a thiol-ene reaction product with a degradable acrylate functional group. The thiol-based polymer was then immersed completely in fresh water at room temperature (a temperature below the glass transition) and fresh water at 90° C. (a temperature above the glass transition). After 3 weeks, the thiol-based polymer in fresh water at room temperature showed no visually observable degradation. However, after only 3 days in the fresh water at 90° C., the thiol-based polymer was observed as absorbing water, increasing in size, and discoloring, and, after 2 weeks was completely dissolved into a sludge-like substance having no remaining mechanical properties.

Therefore, the disclosed systems and methods are well adapted to attain the ends and advantages mentioned as well as those that are inherent therein. The particular embodiments disclosed above are illustrative only, as the teachings of the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present disclosure. The systems and methods illustratively disclosed herein may suitably be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

The invention claimed is:

1. A degradable downhole tool or component thereof comprising a thiol-based polymer having at least one thiol functional group,
wherein the thiol-based polymer is capable of at least partially degrading in a wellbore environment, thereby at least partially degrading the downhole tool or component thereof.

2. The downhole tool or component thereof of claim 1, wherein the thiol-based polymer comprises between about 1 and about 22 thiol functional groups.

3. The downhole tool or component thereof of claim 1, wherein the thiol-based polymer is selected from the group consisting of a thiol-ene reaction product, a thiol-yne reaction product, a thiol-epoxy reaction product, and any combination thereof.

4. The downhole tool of claim 1, wherein the thiol-based polymer further comprises at least one of a degradable functional group comprising one or more of a degradable monomer, a degradable oligomer, and a degradable polymer.

5. The downhole tool or component thereof of claim 4, wherein the degradable functional group is selected from the group consisting of an acrylate, a lactide, a lactone, a glycolide, an anhydride, a lactam, an allyl, a polyethylene glycol, a polyethylene glycol-based hydrogel, an aerogel, a poly(lactide), a poly(glycolic acid), a poly(vinyl alcohol), a poly(N-isopropylacrylamide), a poly(ε-caprolactone, a poly(hydroxybutyrate), a polyanhydride, an aliphatic polycarbonate, an aromatic polycarbonate, a poly(orthoester), a poly(hydroxyl ester ether), a poly(orthoester), a poly(amino acid), a poly(ethylene oxide), a polyphosphazene, a poly(phenyllactide), a poly(hydroxybutyrate), a dextran, a chitin, a cellulose, a protein, an aliphatic polyester, and any combination thereof.

6. The downhole tool or component thereof of claim 1, wherein the thiol-based polymer has a glass transition temperature and exhibits a resilient characteristic above the glass transition temperature and a rigid characteristic below the glass transition temperature, and
wherein the downhole tool or component thereof comprises the at least one thiol-based polymer having the resilient characteristic, the rigid characteristic, or any combination thereof.

7. The downhole tool or component thereof of claim 1, wherein the thiol-based polymer further comprises a reinforcing material selected from the group consisting of a particulate, a fiber, a fiber weave, and any combination thereof.

8. The downhole tool or component thereof of claim 1, wherein the downhole tool comprises a wellbore isolation device.

9. The downhole tool or component thereof of claim 8, wherein the wellbore isolation device is selected from the group consisting of a mandrel, a ball, a plug, a wiper, a sealing element, a spacer ring, a slip, a wedge, a retainer ring, an extrusion limiter, an o-ring, a backup shoe, a mule shoe, a tapered shoe, a flapper, a ball seat, a sleeve, a cage, a fluid enclosure, and any combination thereof.

10. A method comprising:
providing a downhole tool, wherein the downhole tool or a component thereof comprises a thiol-based polymer, and
wherein the thiol-based polymer is capable of at least partially degrading in a wellbore environment, thereby at least partially degrading the downhole tool or component thereof;
introducing the downhole tool into the wellbore;
performing a downhole operation; and
at least partially degrading the downhole tool or component thereof in the wellbore.

11. A method of claim 10, further comprises removing the degraded downhole tool or component thereof from the wellbore.

12. The method of claim 10, wherein the thiol-based polymer comprises between 1 and 22 thiol functional groups.

13. The method of claim 10, wherein the thiol-based polymer is selected from the group consisting of a thiol-ene, a thiol-yne, a thiol-epoxy, and any combination thereof.

14. The method of claim 10, wherein the thiol-based polymer further comprises at least one of a degradable functional group comprising one or more of a degradable monomer, a degradable oligomer, and a degradable polymer.

15. The method of claim 10, wherein the thiol-based polymer has a glass transition temperature and exhibits a resilient characteristic above the glass transition temperature and a rigid characteristic below the glass transition temperature, and
wherein the downhole tool or component thereof comprises the at least one thiol-based polymer having the resilient characteristic, the rigid characteristic, or any combination thereof.

16. The method of claim 10, wherein the thiol-based polymer further comprises a reinforcing material selected from the group consisting of a particulate, a fiber, a fiber weave, and any combination thereof.

17. The method of claim 10, wherein the downhole tool comprises a wellbore isolation device.

18. The method of claim 17, wherein the wellbore isolation device is selected from the group consisting of a mandrel, a ball, a plug, a wiper, a sealing element, a spacer ring, a slip, a wedge, a retainer ring, an extrusion limiter, an o-ring, a backup shoe, a mule shoe, a tapered shoe, a flapper, a ball seat, a sleeve, a cage, a fluid enclosure, and any combination thereof.

19. A system comprising:
a wellbore; and
a downhole tool capable of being disposed in the wellbore to perform a downhole operation, the downhole tool or a component thereof comprising a thiol-based polymer having at least one thiol functional group, and
wherein the thiol-based polymer is capable of at least partially degrading in the wellbore environment, thereby at least partially degrading the downhole tool or component thereof.

20. The system of claim 19, wherein the thiol-based polymer comprises between about 1 and about 22 thiol functional groups.

21. The system of claim 19, wherein the thiol-based polymer is selected from the group consisting of a thiol-ene, a thiol-yne, a thiol-epoxy, and any combination thereof.

22. The system of claim 19, wherein the thiol-based polymer further comprises at least one of a degradable functional group comprising one or more of a degradable monomer, a degradable oligomer, and a degradable polymer.

23. The system of claim 19, wherein the thiol-based polymer has a glass transition temperature and exhibits a resilient characteristic above the glass transition temperature and a rigid characteristic below the glass transition temperature, and
wherein the downhole tool or component thereof comprises the at least one thiol-based polymer having the resilient characteristic, the rigid characteristic, or any combination thereof.

24. The method of claim 19, wherein the thiol-based polymer further comprises a reinforcing material selected from the group consisting of a particulate, a fiber, a fiber weave, and any combination thereof.

25. The method of claim 19, wherein the downhole tool comprises a wellbore isolation device.

26. The method of claim 26, wherein the wellbore isolation device is selected from the group consisting of a mandrel, a ball, a plug, a wiper, a sealing element, a spacer ring, a slip, a wedge, a retainer ring, an extrusion limiter, an o-ring, a backup shoe, a mule shoe, a tapered shoe, a flapper, a ball seat, a sleeve, a cage, a fluid enclosure, and any combination thereof.
